(19) United States
(12) Patent Application Publication
(10) Pub. No.: US 2010/0150492 A1
(43) Pub. Date: Jun. 17, 2010

(54) ANTI-FRICTION BEARING HAVING A BRAKE DEVICE

(75) Inventors: Christian Nuissl, Nuernberg (DE); Juergen Stoelzle, Erlangen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/670,146

(22) PCT Filed: May 28, 2008
(86) PCT No.: PCT/EP08/56542

§ 371 Date: Feb. 9, 2010

(30) Foreign Application Priority Data
Jul. 25, 2007 (DE) 10 2007 034 555.2

(51) Int. Cl. F16C 33/58

(52) U.S. Cl. 384/569

(57) ABSTRACT

The invention relates to an anti-friction bearing (1) having a brake device, in particular a revolving joint, consisting of a bearing outer ring (2) and a bearing inner ring (3) between which anti-friction elements roll on associated raceways, wherein a braking effect by means of frictional engagement is achieved by pressing a displaceable brake element, which is connected to one of the bearing rings (3, 2) and has a brake lining (15), against a opposing surface (23), which is connected to the other bearing ring (2, 3). According to the invention, the opposing surface (23) is provided with a friction-increasing coating (24) which consists of a base material (25) and at least one incorporated additional material (26).

### FIELD OF THE INVENTION

The invention relates to an anti-friction bearing having a brake device, in particular rotary joint, composed of a bearing outer ring and a bearing inner ring, between which rolling bodies roll on associated raceways, with a movable brake element which is connected to one of the bearing rings being pressed with a brake lining against a mating surface, which is connected to the other bearing ring, in order to obtain a braking action by means of frictional engagement.

### BACKGROUND OF THE INVENTION

Anti-friction bearings having a brake device have already been known for a long time. For example, anti-friction bearing rotary joints on windpower plants run the risk of failure after a relatively short time as a result of ripple formation in the raceways. This phenomenon is caused in particular by small pivoting movements for compensating the wind direction, during which pivoting movements the rolling bodies slide on the raceways. To eliminate said wear, it is known to increase the low resistance to rotation in anti-friction bearings using different measures. In this context, DE 37 25 972 A1 and DE 41 04 137 A1 propose the use of an additionally rotating brake device. The braking force and therefore the desired resistance to rotation can then be set externally. A disadvantage here is that, in the first case, the brake element can be removed only when the windpower plant is at a standstill. In the second case, the brake device is composed of numerous mechanical individual parts, and is therefore complex to produce and complicated to handle.

DE 19 04 954 B discloses a pivotless rotary joint for excavators, cranes or the like for mounting a pivotable superstructure on a substructure. Said rotary joint is composed in each case of a single-piece rotary ring and a two-part further rotary ring which is composed of two profiled rings. The two rotary rings are supported against one another in each case by means of the balls of a double-row ball bearing, and are equipped with a brake device. The brake devices have in each case one or more brake pad carriers which are fastened to a stationary component which is connected to the single-piece rotary ring. In said arrangement, it is disadvantageous that the brake devices are arranged outside the bearing arrangement itself and therefore take up additional installation space.

DE 101 27 487 A1 has disclosed a further bearing arrangement with a braking function. The radial bearing arrangement according to FIG. 1 has a deep-groove ball bearing which is designed as a radial bearing, and a brake device arranged axially adjacent thereto. The deep-groove ball bearing is composed of the inner ring, the outer ring and bearing balls arranged between the two in a cage. Furthermore, the deep-groove ball bearing has two sealing rings which seal the annular chamber on both sides with respect to the environment. The brake device has an inner retaining ring and an outer retaining ring. A brake disk is fastened by means of a flat-wire spring to a radially outwardly directed flange of the inner retaining ring, which brake disk is composed of a ferromagnetic material and, on its side facing away from the flange, has a brake lining. As a result of the fastening by means of the flat-wire spring, the brake disk is rotationally fixedly connected to the inner retaining ring and is movable in the axial direction. A mating surface is formed opposite the brake lining on the outer retaining ring, against which mating surface the brake lining is pressed during braking. The outer retaining ring also has an electrical coil and one or more permanent magnets which are arranged in each case in the region between the brake disk and the deep-groove ball bearing and which are mechanically connected to the outer retaining ring and therefore also to the mating surface.

A disadvantage here is that the brake device, as an external part, must be flange-mounted on the bearing in the axial direction and therefore takes up additional installation space. The retaining rings are of relatively complex design and must first be connected to the bearing rings in a complex manner by means of pins. A further disadvantage arises from the fact that the braking action is imparted by a permanent magnet, which attracts the brake disk. In certain applications, however, a constant magnetic field is a disadvantage since, under some circumstances, iron-containing dirt is attracted by the bearing.

Furthermore, all the above-described bearings with brake devices have the disadvantage that the brake device must be designed to be large on account of the relatively weak braking action, which demands a large amount of installation space.

### SUMMARY OF THE INVENTION

The invention is therefore based on the object of avoiding the disadvantages stated above and of providing a brake device which is simple to produce and which imparts a significantly improved braking action and which takes up minimal installation space.

According to the invention, said object is achieved according to the characterizing part of claim 1 in conjunction with the preamble thereof in that the mating surface is provided with a friction-increasing coating which is composed of a basic material and at least one incorporated additive material.

Therefore, the present brake device according to the invention of the anti-friction bearing has the advantage over the brake arrangements mentioned in the introduction that, as a result of the coating, the overall coefficient of friction of the bearing arrangement is significantly increased. Since the friction value has a direct influence on the size of the overall system, it is possible either for the structural unit to be dimensioned to be smaller while maintaining a constant friction power, which leads to cost and installation space advantages, or for the friction power to be increased while maintaining constant dimensioning of the bearing arrangement, such that greater braking forces can be transmitted. This is supplemented by the further advantage that the coefficient of friction settles significantly more quickly to its nominal value, that is to say the run-in behaviour of the friction partners is improved.

Here, according to a further feature of the invention, it has proven to be advantageous for the additive material to have a particle size of ≦3 μm.

In one refinement of the invention, it is provided, according to an additional feature, that the basic material is an electrolessly deposited nickel-phosphor layer and the incorporated additive material is composed of a plastic, boron nitride, diamond or silicon carbide.

As a person skilled in the art knows, chemical nickel layers are deposited by electroless plating. For this purpose, the workpiece to be coated is dipped into an aqueous solution. The nickel ions contained in the solution are reduced by means of electrons of the hypophosphite ions to form metallic nickel. The hypophosphite in turn releases phosphor in the presence of a catalyst, which phosphor is incorporated into the layer. Here, workpieces composed of iron materials themselves act as a catalyst. Also, even the nickel layer which is formed has a catalytic effect, such that the deposition is ended only when the workpiece is removed. Chemical nickel plating has the advantage of providing uniformly thick layers. It is possible for all regions of the workpiece to be coated with the same layer thickness, even sharp edges, cavities and undercuts. In contrast, in galvanic deposition, non-uniform layer thicknesses can be formed as a result of locally different current densities. As a result of the phosphor content, the chemical nickel layers differ in part considerably from the phosphor-free galvanically deposited or metallurgically produced layers. A change in the phosphor content influences the properties of the layers in a highly targeted fashion, with the phosphor concentration being decisive for numerous functional layer properties. Autocatalytic nickel-phosphor coatings are deposited primarily to improve corrosion protection and to increase wear resistance.

According to a further feature, however, it has proven to be advantageous for the mass fraction of phosphor to be ≦8% because a high level of wear resistance is provided at said value, which is particularly important within the context of the invention. A good level of wear resistance of the nickel-phosphor coating is provided with a layer thickness in the range from 10 to 20 μm.

It has proven to be particularly advantageous for the nickel layer to have added to it additive material in the form of silicon carbide which has a grain size of 0.6-1.5 μm. As a result of this embedding of silicon carbide particles, the hardness and wear resistance of the electrolessly deposited nickel-phosphor layers are increased both at normal and also at elevated temperatures. The specified grain size is advantageous because, with a larger grain size, destruction of the friction lining is to be expected. In this connection, it has also proven to be advantageous for the silicon carbide to be incorporated in the nickel-phosphor layer at a rate of between 30 and 35% by volume.

It is also advantageous for the brake element to be formed from a ferromagnetic armature plate which is connected to the brake lining and which is held in an axially movable manner in the bearing inner ring by means of a plurality of guide pins spaced apart in the circumferential direction and which is acted on with a preload by means of a plurality of spring elements spaced apart in the circumferential direction, and from a coil which is arranged in the bearing inner ring, with an air gap being formed between the armature plate and the bearing inner ring when the coil is in the currentless state.

In this way, a bearing arrangement having a brake device is created in which the brake device requires virtually no additional installation space because it is an integral part of the bearing. By accommodating the brake element in one of the bearing rings, normally in the rotating bearing ring, it is possible in this way for the anti-friction bearing having a brake device to be realized in a space-saving manner. A further advantage is that, as a result of the arrangement of the brake device as an integral constituent part of the anti-friction bearing, said brake device need not be additionally connected to the bearing arrangement in a cumbersome manner. It is also advantageous that, by using differently dimensioned springs, it is possible in a simple manner to influence the magnitude of the preload force and, therefore, also the braking force to be applied.

According to another further feature, it is provided that the mating surface is produced from a steel material and is formed as a circular-ring-shaped pressure plate which is connected to the bearing outer ring. Steel material has the advantage firstly that it can transmit high forces on account of its high strength, and secondly that it can be coated with the nickel-phosphor layer without any problems.

According to a further additional feature, the rolling bodies should be formed by bearing needles of two oppositely-aligned axial angular-contact needle bearings, with a point of intersection of the projected rotational axes of said rolling bodies being situated in the bearing inner ring or in the bearing outer ring. In relation to the known rotary joints which are designed preferably as four-point bearings or as crossed roller bearings, production is significantly less expensive for the same or higher load rating when using two axial angular-contact needle bearings. In this connection, according to a further feature of the invention, it has also proven to be advantageous for the rolling bodies to be formed by bearing balls which are set in an O-shaped arrangement relative to one another. On account of the improved rolling conditions of the bearing balls, anti-friction bearings of said type can preferably be used in particular for dynamic applications.

Finally, according to a final feature of the invention, it is provided that the bearing inner ring is formed in two parts for the purpose of adjusting the preload, with said bearing inner ring being connected to an adjusting nut which is movable in the axial direction. In this way, it is possible in a simple manner to act upon the bearing preload by adjusting the two anti-friction bearings which are spaced apart in the axial direction.

Further features of the invention will emerge from the following description and from the drawings which illustrate an exemplary embodiment of the invention in simplified form.

### BRIEF DESCRIPTION OF THE DRAWINGS

In the drawings:

FIG. 1 shows an axial section through an anti-friction bearing designed according to the invention along the line I-I in FIG. 2;

FIG. 2 shows a side view of the anti-friction bearing according to the invention; and

FIG. 3 shows a graphic depiction of a scanning electron microscope image of nickel-phosphor coatings with incorporated silicon carbide.

### DETAILED DESCRIPTION OF THE DRAWINGS

Reference is made firstly to the structural design of the anti-friction bearing 1.

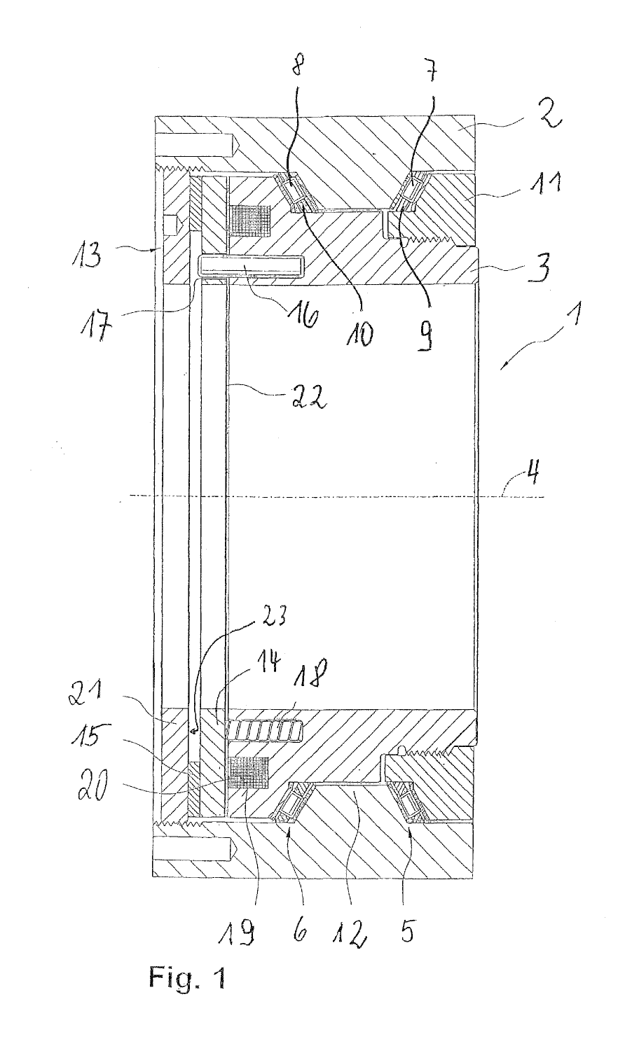

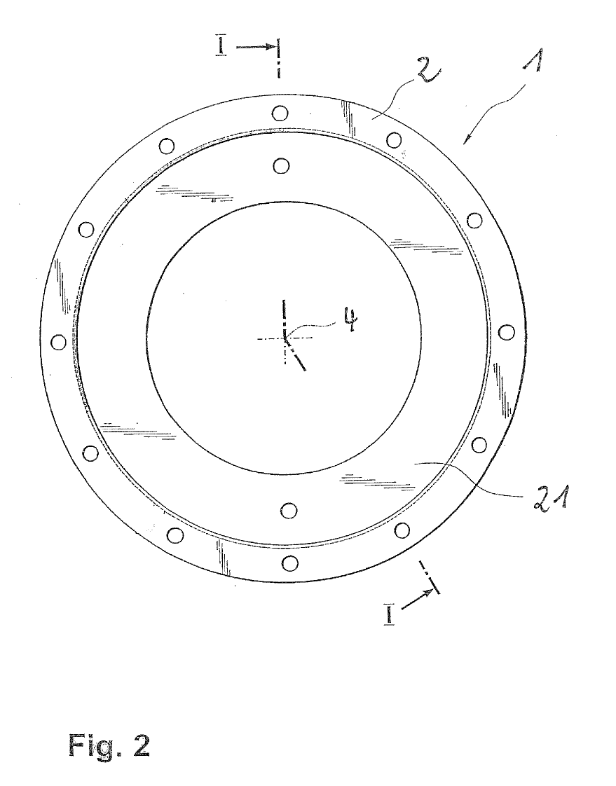

The anti-friction bearing 1 which is illustrated in FIGS. 1 and 2 is composed of the bearing outer ring 2 and the bearing inner ring 3, which are arranged one inside the other concentrically around the bearing axis 4. Arranged in the annular chamber formed between said bearing outer ring 2 and bearing inner ring 3 are axial angular-contact needle bearings 5, 6 which are set in an O-shaped arrangement relative to one another. Both have rolling bodies in the form of bearing needles 7, 8 which are each guided in one cage 9, 10, with the projected rotational axes of the bearing needles 7, 8 intersecting at a point which is situated in the bearing inner ring 3. The axial angular-contact needle bearings 5, 6 have in each case two running disks which are not illustrated in greater detail and which constitute the raceways for the bearing needles 7, 8. FIG. 1 shows that the angle of inclination of the bearings 5, 6 can be variable, and therefore the ratio of radial and axial force absorption can be influenced. As can also be seen, the bearing inner ring 3 is formed in two parts, with the adjusting nut 11 being screwed with its internal thread (not specified) onto an external thread (not specified) of the bearing inner ring 3, and, therefore, being movable in the axial direction. In this way, the bearing preload can be adjusted in a simple manner by tightening the adjusting nut 11, with the two axial angular-contact needle bearings 5, 6 being pressed against the V-shaped projection 12 of the bearing outer ring 2.

The brake element 13 according to the invention is composed of the ferromagnetic armature plate 14, which is of circular ring-shaped design and which is provided on its axially outwardly pointing end side with the brake lining 15. The other end side of the armature plate 14 bears against the end side of the bearing inner ring 3 and is connected to the latter by means of guide pins 16. Here, a plurality of spaced-apart guide pins 16 are fixedly positioned in the bearing inner ring 3 in the circumferential direction. Said guide pins 16 engage into associated bores 17 of the armature plate 14, with the bores 17 being slightly larger in diameter than the diameter of the guide pins 16. In this way, it is ensured that the armature plate 14 is held in an axially movable manner in the bearing inner ring 3, with said armature plate 14 being placed under preload by spring elements 18 which are spaced apart uniformly in the circumferential direction. As can also be seen, the bearing inner ring 3 is provided with a recess 19 which is open in the axial direction and in which the coil 20 is arranged. The brake element 13 also comprises the pressure plate 21 which is held by means of its external thread in the bearing outer ring 2 by means of its internal thread. In this way, it is possible to adjust the air gap 22 by varying the axial position of the pressure plate 21 in the bearing outer ring 2.

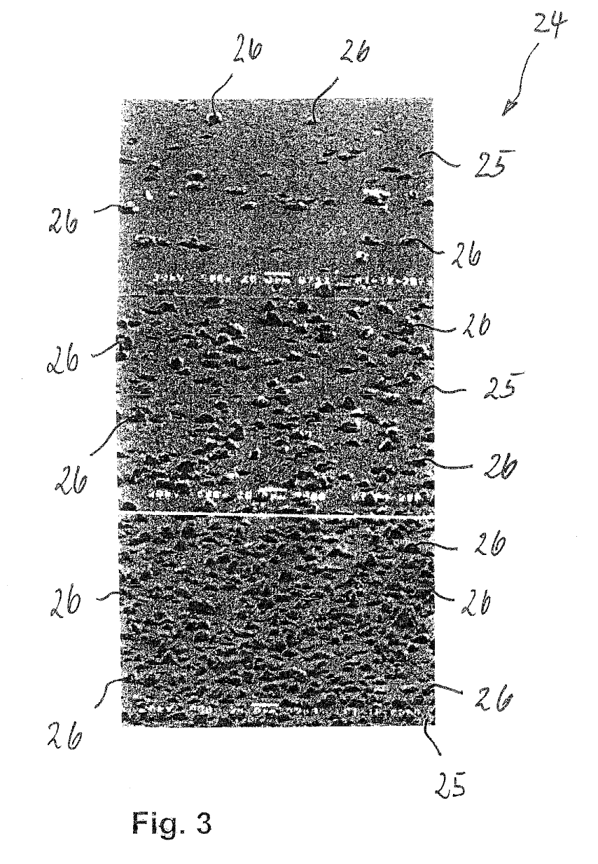

The pressure plate 21, which is produced from a steel material, is subjected, before being installed in the anti-friction bearing 1, to a corresponding pre-treatment in order to improve the adhesion of the coating 24. For example, it must be noted that the cleaning, degreasing and activation must be very intensive in order not only to remove metallurgically inhomogeneous surface layers and inorganic passive layers, but also to create a catalytically active surface for the nickel-plating process. The pressure plate 21 is subsequently coated autocatalytically over its entire surface with a nickel-phosphor coating 24 by being dipped into a corresponding bath solution. For this purpose, in many cases, use is made of hypophosphite-based baths in which the reducing agent is a sodium hypophosphite electron donor for the reduction of the nickel ions. Said layer 24 accordingly also extends over that side surface of the pressure disk 21 which faces toward the brake lining 15 and which is referred to as the mating surface 23. The coating 24 has a thickness of 12 μm and is composed, as can be seen from FIG. 3, of the basic material 25 in the form of nickel phosphor and the incorporated additive material 26 in the form of silicon carbide. Here, as also shown in FIG. 3, the rate of incorporation of the silicon carbide can increase from top to bottom. This means that, depending on the given application, any desired number of silicon carbides can be incorporated. Said incorporated silicon carbide particles increase the hardness and wear resistance of the electrolessly deposited nickel-phosphor layer both at normal temperatures and also at elevated temperatures. The pressure plate 21, which is provided with an Ni—SiC dispersion layer 24 of said type, attains a friction coefficient of 0.7 to 0.9, while in the prior art, friction coefficients between brake linings and steel of 0.3 to 0.4 are conventional. As a result of the increase in friction coefficient, it is possible to realize significantly higher levels of braking power, such that the brake device has a comparatively small spatial requirement. The electrolessly deposited nickel-phosphor coating with the incorporated SiC particles results in a material compound which has a high hardness, very good wear and abrasion resistance, good corrosion resistance and good chemical resistance, wherein the first three properties are of particular significance within the context of the invention.

### REFERENCE NUMERALS

1 Anti-friction bearing
2 Bearing outer ring
3 Bearing inner ring
4 Bearing axis
5 Axial angular-contact needle bearing
6 Axial angular-contact needle bearing
7 Bearing needle
8 Bearing needle
9 Cage
10 Cage
11 Adjusting nut
12 Projection
13 Brake element
14 Armature plate
15 Brake lining
16 Guide pin
17 Bore
18 Spring element
19 Recess
20 Coil
21 Pressure plate
22 Air gap
23 Mating surface
24 Coating
25 Basic material
26 Additive material

1. An anti-friction bearing, comprising:
a brake device, in particular rotary joint, having a bearing outer ring; and a bearing inner ring, between which rolling bodies roll on associated raceways, with a movable brake element which is connected to one of the bearing rings being pressed with a brake lining against a mating surface, which is connected to the other bearing ring, in order to obtain a braking action by means of frictional engagement,
wherein the mating surface is provided with a friction-increasing coating which is composed of a basic material and at least one incorporated additive material.

2. The anti-friction bearing of claim 1, wherein the additive material has a particle size of ≦3 μm.

3. The anti-friction bearing of claim 1, wherein the basic material is an electrolessly deposited nickel-phosphor layer and the additive material is composed of a plastic, boron nitride, diamond or silicon carbide.

4. The anti-friction bearing of claim 3, wherein the nickel-phosphor layer comprises a mass fraction of phosphor of ≦8%.

5. The anti-friction bearing of claim 3, wherein the nickel-phosphor layer has a thickness of 10 to 20 μm.

6. The anti-friction bearing of claim 3, wherein the silicon carbide has a grain size of 0.6-1.5 μm.

7. The anti-friction bearing of claim 3, wherein the nickel-phosphor layer has a rate of incorporation of 30-35% by volume of silicon carbide.

8. The anti-friction bearing of claim 1, wherein a brake element is formed from a ferromagnetic armature plate which is connected to the brake lining and which is held in an axially movable manner in the bearing inner ring by means of a plurality of guide pins spaced apart in a circumferential direction and which is acted on with a preload by means of a plurality of spring elements spaced apart in the circumferential direction, and from a coil which is arranged in the bearing inner ring, with an air gap being formed between an armature plate and the bearing inner ring when the coil is in a currentless state.

9. The anti-friction bearing of claim 1, wherein the mating surface is produced from a steel material and is formed as a circular-ring-shaped pressure plate which is connected to the bearing outer ring.

10. The anti-friction bearing of claim 1, wherein the rolling bodies are formed by hearing needles of two oppositely-aligned axial angular-contact needle bearings, with a point of intersection of a projected rotational axes of the rolling bodies being situated in the bearing inner ring or in the bearing outer ring.

11. The anti-friction bearing of claim 1, wherein the rolling bodies are formed by bearing balls which are set in an O-shaped arrangement relative to one another.

12. The anti-friction bearing of claim 1, wherein the bearing inner ring is formed in two parts for adjusting the preload, with the bearing inner ring being connected to an adjusting nut which is movable in an axial direction.
